(19) United States
(12) Patent Application Publication
(10) Pub. No.: US 2026/0107014 A1
(43) Pub. Date: Apr. 16, 2026

(54) VECTOR QUANTIZATION BASED POINT CLOUD / IMAGE COMPRESSION

(71) Applicant: InterDigital VC Holdings, Inc., Wilmington, DE (US)

(72) Inventors: Jiahao Pang, Plainsboro, NJ (US); Ezgi Ozyilkan, Brooklyn, NY (US); Muhammad Asad Lodhi, Highland Park, NJ (US); Dong Tian, Boxborough, MA (US)

(21) Appl. No.: 18/912,360

(22) Filed: Oct. 10, 2024

(51) Int. Cl. H04N 19/597; H04N 19/124

(52) U.S. Cl. CPC H04N 19/597; H04N 19/124

(57) ABSTRACT

Some embodiments of a method may include: accessing a first bitstream representing a list of feature descriptors; obtaining a codebook comprising one or more codewords, wherein the one or more codewords comprise a first set of one-hot indexes or vectors; obtaining a probability distribution over the one or more codewords, wherein the probability distribution is learned by a neural network; decoding a second set of one or more one-hot indexes from the first bitstream, wherein each one-hot index of the second set is associated with a feature descriptor in the list of feature descriptors; decoding each feature descriptor based on the codebook and the respective one-hot index of the second set; and reconstructing an approximation of input data based on the decoded feature descriptors

### INCORPORATION BY REFERENCE

The present application incorporates by reference in their entirety the following applications: U.S. patent application Ser. No. 18/679,144, entitled “END-TO-END LEARNING-BASED POINT CLOUD CODING FRAMEWORK” and filed May 30, 2024 (“'144 application”).

### BACKGROUND

The present application is related to learning-based image/video and point cloud compression.

### SUMMARY

A first example method in accordance with some embodiments may include: accessing a first bitstream, wherein the first bitstream represents a list of feature descriptors; obtaining a codebook comprising one or more codewords, wherein the one or more codewords comprise a first set of one-hot indexes or vectors; obtaining a probability distribution over the one or more codewords, wherein the probability distribution is learned by a neural network; decoding a second set of one or more one-hot indexes from the first bitstream, wherein each one-hot index of the second set is associated with a feature descriptor in the list of feature descriptors; decoding each feature descriptor based on the codebook and the respective one-hot index of the second set; and reconstructing an approximation of input data based on the decoded feature descriptors.

For some embodiments of the first example method, the list of feature descriptors corresponds to a point cloud.

For some embodiments of the first example method, the list of feature descriptors corresponds to an image.

For some embodiments of the first example method, the list of feature descriptors corresponds to video data.

For some embodiments of the first example method, obtaining the probability distribution over the one or more codewords comprises passing context data through one or more multi-layer perceptron (MLP) blocks and one or more rectifier linear unit (ReLU) blocks.

For some embodiments of the first example method, decoding the one or more one-hot indexes comprises: obtaining one or more features from the first bitstream; and passing the one or more features through an arithmetic decode process to generate the one or more one-hot indexes, wherein the arithmetic decode process uses the probability distribution as an input parameter.

Some embodiments of the first example method may further include extracting side information from a second bitstream, wherein the second bitstream comprises feature encoded information corresponding to the input data, and wherein decoding each feature descriptor further uses the extracted side information.

For some embodiments of the first example method, obtaining the probability distribution comprises using a neural parameterized entropy bottleneck process operating on the codebook.

For some embodiments of the first example method, the approximation of the input data comprises a quantized version of an image or data feature.

For some embodiments of the first example method, the approximation of the input data comprises a quantized version of a point cloud feature.

A first example apparatus in accordance with some embodiments may include: a processor; and a memory storing instructions operative, when executed by the processor, to cause the apparatus to: access a first bitstream, wherein the first bitstream represents a list of feature descriptors; obtain a codebook comprising one or more codewords, wherein the one or more codewords comprise a first set of one-hot indexes or vectors; obtain a probability distribution over the one or more codewords, wherein the probability distribution is learned by a neural network; decode a second set of one or more one-hot indexes from the first bitstream, wherein each one-hot index of the second set is associated with a feature descriptor in the list of feature descriptors; decode each feature descriptor based on the codebook and the respective one-hot index of the second set; and reconstruct an approximation of input data based on the decoded feature descriptors.

A second example method in accordance with some embodiments may include: obtaining a list of feature descriptors; obtaining a codebook comprising one or more codewords, wherein the one or more codewords comprise a first set of one-hot indexes or vectors; determining a second set of one or more one-hot indexes by processing an extracted feature using a neural network-based encoder; obtaining a probability distribution over the one or more codewords, wherein the probability distribution is learned by a neural network; and encoding the second set of one or more one-hot indexes into a bitstream.

For some embodiments of the second example method, obtaining the list of feature descriptors comprises extracting the list of feature descriptors using a neural network.

For some embodiments of the second example method, obtaining the list of feature descriptors comprises extracting the list of feature descriptors from a point cloud, an image, or video data.

For some embodiments of the second example method, obtaining the list of feature descriptors comprises generating the list of feature descriptors from scratch.

For some embodiments of the second example method, obtaining the probability distribution over the one or more codewords comprises passing context data through one or more multi-layer perceptron (MLP) blocks and one or more rectifier linear unit (ReLU) blocks.

For some embodiments of the second example method, determining the second set of one or more one-hot indexes comprises: obtaining one or more features; and passing the one or more features through an arithmetic decode process to generate the second set of one or more one-hot indexes, wherein the arithmetic decode process uses the probability distribution as an input parameter.

Some embodiments of the second example method may further include: extracting side information from the extracted feature; and encoding the extracted feature into a second bitstream, wherein encoding the extracted feature uses the extracted side information as a parameter.

For some embodiments of the second example method, at least one of the feature descriptors of the list of feature descriptors corresponds to an image or data feature.

For some embodiments of the second example method, at least one of the feature descriptors of the list of feature descriptors corresponds to a point cloud feature.

### BRIEF DESCRIPTION OF THE DRAWINGS

The following detailed description will be better understood when read in conjunction with the appended drawings, in which there are shown examples of one or more of the multiple embodiments of the present application. It should be understood, however, that the embodiments described herein are not limited to the precise arrangements and instrumentalities shown in the drawings. In the drawings:

FIG. 1A is a system diagram illustrating an example set of interfaces for a system according to some embodiments.

FIG. 1B is a schematic side view illustrating an example waveguide display that may be used with extended reality (XR) applications according to some embodiments.

FIG. 1C is a schematic side view illustrating an example alternative display type that may be used with extended reality applications according to some embodiments.

FIG. 1D is a schematic side view illustrating an example alternative display type that may be used with extended reality applications according to some embodiments.

FIG. 2A is a process diagram illustrating an example feature extraction from point cloud data according to some embodiments.

FIG. 2B is a process diagram illustrating an example feature encoding using vector quantization according to some embodiments.

FIG. 3 is a process diagram illustrating example pre-arithmetic encoder processing according to some embodiments.

FIG. 4 is a process diagram illustrating an example probability estimator for codewords in a vector quantizer according to some embodiments.

FIG. 5 is a process diagram illustrating an example feature decoder using vector quantization according to some embodiments.

FIG. 6 is a process diagram illustrating example vector quantization for lossy point cloud compression according to some embodiments.

FIG. 7 is a process diagram illustrating an example vector quantization for lossless point cloud compression according to some embodiments.

FIG. 8A is a process diagram illustrating an example feature extraction from image/video data according to some embodiments.

FIG. 8B is a process diagram illustrating an example feature encoding for image/video data using vector quantization according to some embodiments.

FIG. 9 is a process diagram illustrating an example vector quantization for lossy image/video compression according to some embodiments.

FIG. 10 is a flowchart illustrating an example decoding process according to some embodiments.

FIG. 11 is a flowchart illustrating an example encoding process according to some embodiments.

The entities, connections, arrangements, and the like that are depicted in—and described in connection with—the various figures are presented by way of example and not by way of limitation. As such, any and all statements or other indications as to what a particular figure “depicts,” what a particular element or entity in a particular figure “is” or “has,” and any and all similar statements—that may in isolation and out of context be read as absolute and therefore limiting—may only properly be read as being constructively preceded by a clause such as “In at least one embodiment, . . . .” For brevity and clarity of presentation, this implied leading clause is not repeated ad nauseum in the detailed description.

### DETAILED DESCRIPTION

In describing the various embodiments of the present application, certain terminology is used herein for convenience only and should not be considered as limiting such embodiments. In the drawings, the same reference numerals are employed for designating the same elements throughout the several figures and the present description.

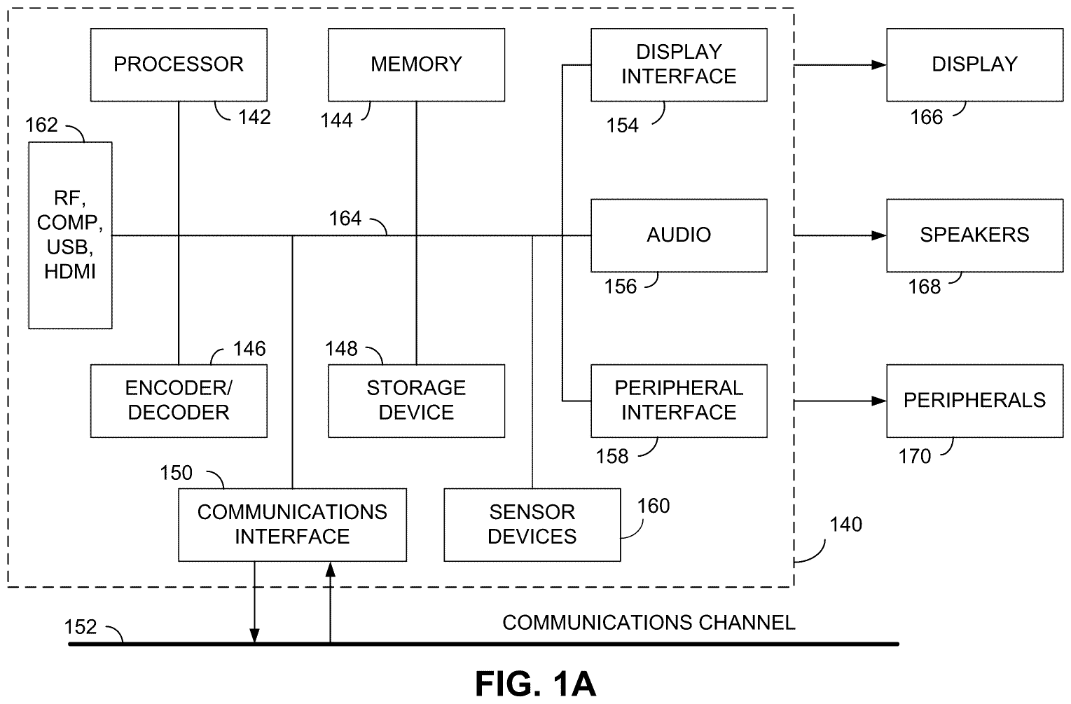

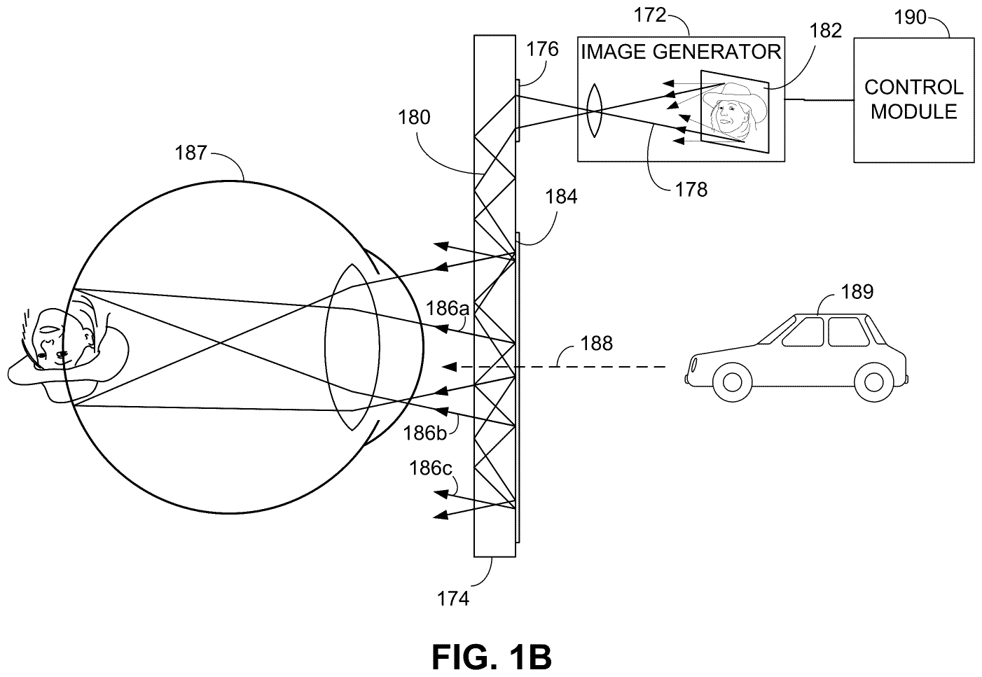

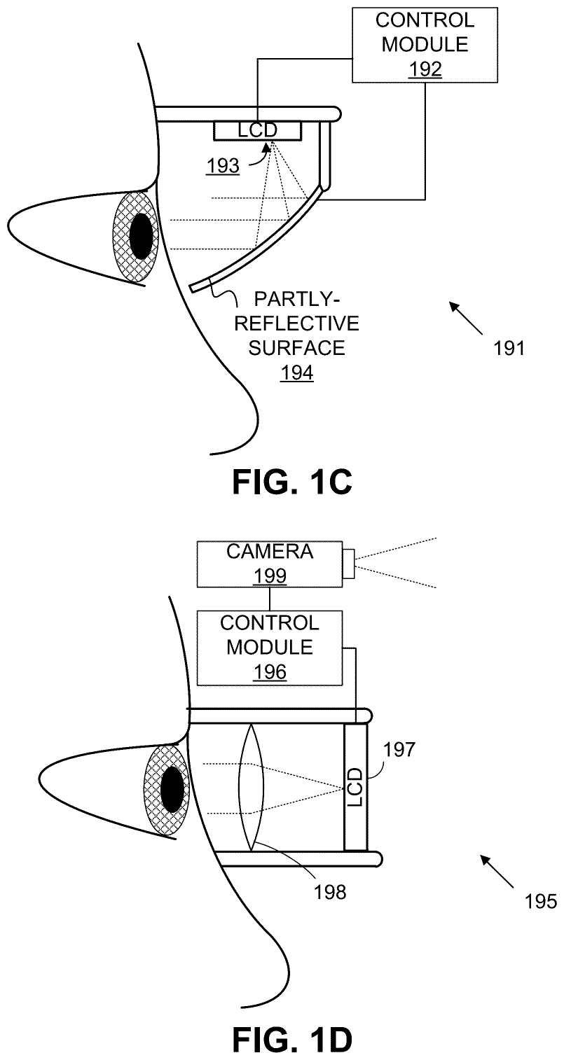

FIG. 1A is a system diagram illustrating an example set of interfaces for a system according to some embodiments. An extended reality display device, together with its control electronics, may be implemented using a system such as the system of FIG. 1A. System 140 can be embodied as a device including the various components described below and is configured to perform one or more of the aspects described in this document. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 140, singly or in combination, can be embodied in a single integrated circuit (IC), multiple ICs, and/or discrete components. For example, in at least one embodiment, the processing and encoder/decoder elements of system 140 are distributed across multiple ICs and/or discrete components. In various embodiments, the system 140 is communicatively coupled to one or more other systems, or other electronic devices, via, for example, a communications bus or through dedicated input and/or output ports. In various embodiments, the system 140 is configured to implement one or more of the aspects described in this document.

The system 140 includes at least one processor 142 configured to execute instructions loaded therein for implementing, for example, the various aspects described in this document. Processor 142 may include embedded memory, input output interface, and various other circuitries as known in the art. The system 140 includes at least one memory 144 (e.g., a volatile memory device, and/or a non-volatile memory device). System 140 may include a storage device 148, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 148 can include an internal storage device, an attached storage device (including detachable and non-detachable storage devices), and/or a network accessible storage device, as non-limiting examples.

System 140 includes an encoder/decoder module 146 configured, for example, to process data to provide an encoded video or decoded video, and the encoder/decoder module 146 can include its own processor and memory. The encoder/decoder module 146 represents module(s) that can be included in a device to perform the encoding and/or decoding functions. As is known, a device can include one or both of the encoding and decoding modules. Additionally, encoder/decoder module 146 can be implemented as a separate element of system 140 or can be incorporated within processor 142 as a combination of hardware and software as known to those skilled in the art.

Program code to be loaded onto processor 142 or encoder/decoder 146 to perform the various aspects described in this document can be stored in storage device 148 and subsequently loaded onto memory 144 for execution by processor 142. In accordance with various embodiments, one or more of processor 142, memory 144, storage device 148, and encoder/decoder module 146 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In some embodiments, memory inside of the processor 142 and/or the encoder/decoder module 146 is used to store instructions and to provide working memory for processing that is needed during encoding or decoding. In other embodiments, however, a memory external to the processing device (for example, the processing device can be either the processor 142 or the encoder/decoder module 142) is used for one or more of these functions. The external memory can be the memory 144 and/or the storage device 148, for example, a dynamic volatile memory and/or a non-volatile flash memory. In several embodiments, an external non-volatile flash memory is used to store the operating system of, for example, a television. In at least one embodiment, a fast external dynamic volatile memory such as a RAM is used as working memory for video coding and decoding operations, such as for MPEG-2 (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or VVC (Versatile Video Coding, a new standard being developed by JVET, the Joint Video Experts Team).

The input to the elements of system 140 can be provided through various input devices as indicated in block 162. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 1A, include composite video.

In various embodiments, the input devices of block 162 have associated respective input processing elements as known in the art. For example, the RF portion can be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which can be referred to as a channel in certain embodiments, (iv) demodulating the downconverted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, downconverting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF portion includes an antenna.

Additionally, the USB and/or HDMI terminals can include respective interface processors for connecting system 140 to other electronic devices across USB and/or HDMI connections. It is to be understood that various aspects of input processing, for example, Reed-Solomon error correction, can be implemented, for example, within a separate input processing IC or within processor 142 as necessary. Similarly, aspects of USB or HDMI interface processing can be implemented within separate interface ICs or within processor 142 as necessary. The demodulated, error corrected, and demultiplexed stream is provided to various processing elements, including, for example, processor 142, and encoder/decoder 146 operating in combination with the memory and storage elements to process the datastream as necessary for presentation on an output device.

Various elements of system 140 can be provided within an integrated housing, Within the integrated housing, the various elements can be interconnected and transmit data therebetween using suitable connection arrangement 164, for example, an internal bus as known in the art, including the Inter-IC (12C) bus, wiring, and printed circuit boards.

The system 140 includes communication interface 150 that enables communication with other devices via communication channel 152. The communication interface 150 can include, but is not limited to, a transceiver configured to transmit and to receive data over communication channel 152. The communication interface 150 can include, but is not limited to, a modem or network card and the communication channel 152 can be implemented, for example, within a wired and/or a wireless medium.

Data is streamed, or otherwise provided, to the system 140, in various embodiments, using a wireless network such as a Wi-Fi network, for example IEEE 802.11 (IEEE refers to the Institute of Electrical and Electronics Engineers). The Wi-Fi signal of these embodiments is received over the communications channel 152 and the communications interface 150 which are adapted for Wi-Fi communications. The communications channel 152 of these embodiments is typically connected to an access point or router that provides access to external networks including the Internet for allowing streaming applications and other over-the-top communications. Other embodiments provide streamed data to the system 140 using a set-top box that delivers the data over the HDMI connection of the input block 162. Still other embodiments provide streamed data to the system 140 using the RF connection of the input block 162. As indicated above, various embodiments provide data in a non-streaming manner. Additionally, various embodiments use wireless networks other than Wi-Fi, for example a cellular network or a Bluetooth network.

The system 140 can provide an output signal to various output devices, including a display 166, speakers 168, and other peripheral devices 170. The display 166 of various embodiments includes one or more of, for example, a touchscreen display, an organic light-emitting diode (OLED) display, a curved display, and/or a foldable display. The display 166 can be for a television, a tablet, a laptop, a cell phone (mobile phone), or other device. The display 166 can also be integrated with other components (for example, as in a smart phone), or separate (for example, an external monitor for a laptop). The other peripheral devices 170 include, in various examples of embodiments, one or more of a stand-alone digital video disc (or digital versatile disc) (DVR, for both terms), a disk player, a stereo system, and/or a lighting system. Various embodiments use one or more peripheral devices 170 that provide a function based on the output of the system 140. For example, a disk player performs the function of playing the output of the system 140.

In various embodiments, control signals are communicated between the system 140 and the display 166, speakers 168, or other peripheral devices 170 using signaling such as AV.Link, Consumer Electronics Control (CEC), or other communications protocols that enable device-to-device control with or without user intervention. The output devices can be communicatively coupled to system 140 via dedicated connections through respective interfaces 154, 156, and 158. Alternatively, the output devices can be connected to system 140 using the communications channel 152 via the communications interface 150. The display 166 and speakers 168 can be integrated in a single unit with the other components of system 140 in an electronic device such as, for example, a television. In various embodiments, the display interface 154 includes a display driver, such as, for example, a timing controller (T Con) chip.

The display 166 and speaker 168 can alternatively be separate from one or more of the other components, for example, if the RF portion of input 162 is part of a separate set-top box. In various embodiments in which the display 166 and speakers 168 are external components, the output signal can be provided via dedicated output connections, including, for example, HDMI ports, USB ports, or COMP outputs.

The system 140 may include one or more sensor devices 160. Examples of sensor devices that may be used include one or more GPS sensors, gyroscopic sensors, accelerometers, light sensors, cameras, depth cameras, microphones, and/or magnetometers. Such sensors may be used to determine information such as user's position and orientation. Where the system 140 is used as the control module for an extended reality display (such as control modules), the user's position and orientation may be used in determining how to render image data such that the user perceives the correct portion of a virtual object or virtual scene from the correct point of view. In the case of head-mounted display devices, the position and orientation of the device itself may be used to determine the position and orientation of the user for the purpose of rendering virtual content. In the case of other display devices, such as a phone, a tablet, a computer monitor, or a television, other inputs may be used to determine the position and orientation of the user for the purpose of rendering content. For example, a user may select and/or adjust a desired viewpoint and/or viewing direction with the use of a touch screen, keypad or keyboard, trackball, joystick, or other input. Where the display device has sensors such as accelerometers and/or gyroscopes, the viewpoint and orientation used for the purpose of rendering content may be selected and/or adjusted based on motion of the display device.

The embodiments can be carried out by computer software implemented by the processor 142 or by hardware, or by a combination of hardware and software. As a non-limiting example, the embodiments can be implemented by one or more integrated circuits. The memory 144 can be of any type appropriate to the technical environment and can be implemented using any appropriate data storage technology, such as optical memory devices, magnetic memory devices, semiconductor-based memory devices, fixed memory, and removable memory, as non-limiting examples. The processor 142 can be of any type appropriate to the technical environment, and can encompass one or more of microprocessors, general purpose computers, special purpose computers, and processors based on a multi-core architecture, as non-limiting examples.

### Scene Description Framework for XR

In some embodiments, examples disclosed herein may be used in the domain of rendering of extended reality scene description and extended reality rendering. For some embodiments, for example, the present application may be applied in the context of the formatting and the playing of extended reality applications when rendered on end-user devices such as mobile devices or Head-Mounted Displays (HMD). For some example embodiments, gITF material may be rendered in a 3D environment that is rendered through a 2D screen. The examples presented herein in accordance with some embodiments are not limited to XR applications.

In XR applications, a scene description is used to combine explicit and easy-to-parse description of a scene structure and some binary representations of media content.

In time-based media streaming, the scene description itself can be time-evolving to provide the relevant virtual content for each sequence of a media stream. For instance, for advertising purpose, a virtual bottle can be displayed during a video sequence where people are drinking.

This kind of behavior can be achieved by relying on the framework defined in the Scene Description for MPEG media document, Information technology—Coded representation of immersive media—Part 14: Scene Description for MPEG media, ISO/IEC DIS 23090-14:2021 (E). A scene update mechanism based on the JSON Patch protocol as defined in IETF RFC 6902 may be used to synchronize virtual content to MPEG media streams.

FIG. 1B is a schematic side view illustrating an example waveguide display that may be used with extended reality (XR) applications according to some embodiments. An image is projected by an image generator 172. The image generator 172 may use one or more of various techniques for projecting an image. For example, the image generator 172 may be a laser beam scanning (LBS) projector, a liquid crystal display (LCD), a light-emitting diode (LED) display (including an organic LED (OLED) or micro LED (μLED) display), a digital light processor (DLP), a liquid crystal on silicon (LCoS) display, or other type of image generator or light engine.

Light representing an image 182 generated by the image generator 172 is coupled into a waveguide 174 by a diffractive in-coupler 176. The in-coupler 176 diffracts the light representing the image 182 into one or more diffractive orders. For example, light ray 178, which is one of the light rays representing a portion of the bottom of the image, is diffracted by the in-coupler 176, and one of the diffracted orders 180 (e.g. the second order) is at an angle that is capable of being propagated through the waveguide 174 by total internal reflection. The image generator 172 displays images as directed by a control module 190, which operates to render image data, video data, point cloud data, or other displayable data.

At least a portion of the light 180 that has been coupled into the waveguide 174 by the diffractive in-coupler 176 is coupled out of the waveguide by a diffractive out-coupler 184. At least some of the light coupled out of the waveguide 174 replicates the incident angle of light coupled into the waveguide. For example, in the illustration, out-coupled light rays 186a, 186b, and 186c replicate the angle of the in-coupled light ray 178. Because light exiting the out-coupler replicates the directions of light that entered the in-coupler, the waveguide substantially replicates the original image 182. A user's eye 187 can focus on the replicated image.

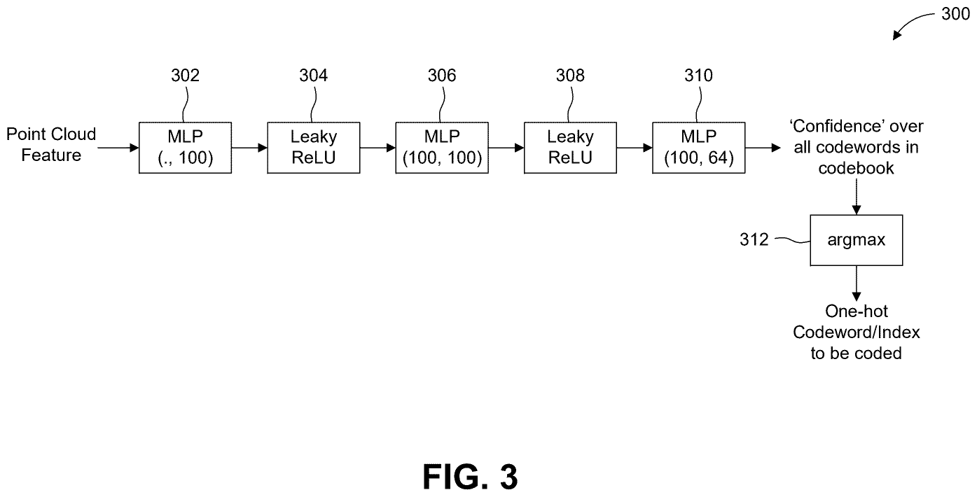

In the example of FIG. 1B, the out-coupler 184 out-couples only a portion of the light with each reflection allowing a single input beam (such as beam 178) to generate multiple parallel output beams (such as beams 186a, 186b, and 186c). In this way, at least some of the light originating from each portion of the image is likely to reach the user's eye even if the eye is not perfectly aligned with the center of the out-coupler. For example, if the eye 187 were to move downward, beam 186c may enter the eye even if beams 186a and 186b do not, so the user can still perceive the bottom of the image 182 despite the shift in position. The out-coupler 184 thus operates in part as an exit pupil expander in the vertical direction. The waveguide may also include one or more additional exit pupil expanders (not shown in FIG. 3A) to expand the exit pupil in the horizontal direction.

In some embodiments, the waveguide 174 is at least partly transparent with respect to light originating outside the waveguide display. For example, at least some of the light 188 from real-world objects (such as object 189) traverses the waveguide 174, allowing the user to see the real-world objects while using the waveguide display. As light 188 from real-world objects also goes through the diffraction grating 184, there will be multiple diffraction orders and hence multiple images. To minimize the visibility of multiple images, it is desirable for the diffraction order zero (no deviation by 184) to have a great diffraction efficiency for light 188 and order zero, while higher diffraction orders are lower in energy. Thus, in addition to expanding and out-coupling the virtual image, the out-coupler 184 is preferably configured to let through the zero order of the real image. In such embodiments, images displayed by the waveguide display may appear to be superimposed on the real world.

FIG. 1C is a schematic side view illustrating an example alternative display type that may be used with extended reality applications according to some embodiments. In an XR head-mounted display device 191, a control module 192 controls a display 193, which may be an LCD, to display an image. The head-mounted display includes a partly-reflective surface 194 that reflects (and in some embodiments, both reflects and focuses) the image displayed on the LCD to make the image visible to the user. The partly-reflective surface 194 also allows the passage of at least some exterior light, permitting the user to see their surroundings.

FIG. 1D is a schematic side view illustrating an example alternative display type that may be used with extended reality applications according to some embodiments. In an XR head-mounted display device 195, a control module 196 controls a display 197, which may be an LCD, to display an image. The image is focused by one or more lenses of display optics 198 to make the image visible to the user. In the example of FIG. 1D, exterior light does not reach the user's eyes directly. However, in some such embodiments, an exterior camera 199 may be used to capture images of the exterior environment and display such images on the display 197 together with any virtual content that may also be displayed.

The embodiments described herein are not limited to any particular type or structure of XR display device.

A User Equipment (UE) may correspond to any eXtended Reality (XR) device/node which may come in variety of form factors. Typical UE (e.g., XR UE) may include, but not limited to the following: Head Mounted Displays (HMD), optical see-through glasses and video see-through HMDs for Augmented Reality (AR) and Mixed Reality (MR), mobile devices with positional tracking and camera, wearables etc. In addition to the above, several different types of XR UE may be envisioned based on XR device functions for e.g., as display, camera, sensors, sensor processing, wireless connectivity, XR/Media processing, and power supply, to be provided by one or more devices, wearables, actuators, controllers and/or accessories. One or more device/nodes/UEs may be grouped into a collaborative XR group for supporting any of XR applications/experience/services.

### Point Cloud Data Format

This application discusses learning-based image/video and point cloud compression. To simplify the writing, point cloud compression is used as an example target field. The field of point cloud compression and processing aims to develop tools for compression, analysis, interpolation, representation and understanding of input signals, such as point clouds.

Point cloud data is a universal data format across several business domains from autonomous driving, robotics, AR/VR, civil engineering, computer graphics, to the animation/movie industry. 3D LiDAR sensors have been deployed in self-driving cars, and affordable LiDAR sensors are released from Velodyne Velabit, Apple iPad Pro 2020 and Intel RealSense LiDAR camera L515. With advances in sensing technologies, 3D point cloud data becomes more practical than ever.

Point cloud data is also believed to consume a large portion of network traffic, e.g., among connected cars over 5G network, and immersive communications (VR/AR). Efficient representation formats may be necessary for point cloud understanding and communication. In particular, raw point cloud data may be organized and processed for the purposes of world modeling and sensing. Compression of raw point clouds may be used when the storage and transmission of the data are used in related scenarios.

Furthermore, point clouds may represent a sequential scan of the same scene, which contains multiple moving objects. They are called dynamic point clouds as compared to static point clouds captured from a static scene or static objects. Dynamic point clouds are typically organized into frames, with different frames being captured at different times. Dynamic point clouds may require the processing and compression to be handled in real-time or with low delay.

Each point of the point cloud may be represented by at least a 3D position (x, y, z). The set of 3D positions illustrates the geometry of the object/scene from which the point cloud is captured. Additionally, each point of the point cloud may be associated with some attributes, depending on the applications. For example, for VR/AR/Gaming, the attribute may include color (r, g, b), and for LiDAR, the attribute may include reflectance.

### Point Cloud Data Use Cases

The automotive industry and autonomous cars are domains in which point clouds may be used. Autonomous cars are able to “probe” their environment to make good driving decisions based on the reality of their immediate surroundings. Typical sensors, like LiDARs, produce (dynamic) point clouds that are used by the perception engine. These point clouds are not intended to be viewed by human eyes, and they are typically sparse, not necessarily colored, and dynamic with a high frequency of capture. They may have other attributes, like the reflectance ratio provided by the LiDAR because this attribute may be indicative of the material of the sensed object, and this attribute may be used in making a decision.

Virtual Reality (VR) and immersive worlds have become a hot topic and are foreseen by many as the future of 2D flat video. The viewer is immersed in an environment all around the viewer as opposed to standard TV in which the viewer may look only at the virtual world in front of the viewer. There are several gradations in the immersivity depending on the freedom of the viewer in the environment. Point clouds are a good format candidate to distribute VR worlds. They may be static or dynamic and are typically of average size, with, e.g., no more than millions of points at a time.

Point clouds also may be used for various purposes, such as cultural heritage/buildings in which objects, like statues or buildings, are scanned in 3D to share the spatial configuration of the object without sending or visiting the statues or buildings. Also, point clouds offer a way to ensure preservation of the knowledge of the object in case the original object, for instance, is destroyed by an earthquake. Such point clouds are typically static, colored, and huge.

Another use case is in topography and cartography in which, when using 3D representations, maps are not limited to the plane and may include the relief. Google Maps is a good example of 3D maps but is understood to use meshes instead of point clouds. Nevertheless, point clouds may be a suitable data format for 3D maps, and such point clouds are typically static, colored, and huge.

World modeling and sensing via point clouds may be a technology that allows machines to gain knowledge about the 3D world around them, which may be used by the applications discussed above.

### General Challenges

3D point cloud data include discrete samples of the surfaces of objects or scenes. A huge number of points may be used to fully represent the real world with point samples. For instance, a typical VR immersive scene may contain millions of points, while point clouds typically contain hundreds of millions of points. Therefore, the processing of such large-scale point clouds may be computationally expensive, especially for consumer devices, such as smartphones, tablets, and automotive navigation systems, that have limited computational power.

The first step for processing or inference on a point cloud is to have efficient storage methodologies. To store and process the input point cloud with affordable computational cost, the point cloud may be down-sampled first, in which the down-sampled point cloud summarizes the geometry of the input point cloud while having much fewer points. The down-sampled point cloud may be inputted into a machine task for further processing. However, further reduction in storage space may be achieved by converting the raw point cloud data (original or down-sampled) into a bitstream through entropy coding techniques for lossless compression.

In addition to lossless coding, many scenarios may use lossy coding for significantly improved compression ratios while maintaining the induced distortion under certain quality levels. To achieve a less lossy coding, an efficient point feature extractor may be used to improve the accuracy of the reconstruction within the given resource budget.

### Learning-Based Point Cloud Compression

Since point cloud data is composed of two components: geometry information and attribute information, the compression of point clouds may be classified into two categories: (1) geometry coding and (2) attribute coding. Examples of existing learning-based point cloud geometry compression techniques include deep octree coding and end-to-end feature-based geometry coding. With deep octree coding, neural network-based models are utilized to estimate the occupancy probabilities. Such estimated probabilities are then used to help the arithmetic coder to encode or decode a binary flag indicating whether a child octree voxel is occupied or empty.

In the realm of neural compression, the prevalent neural compressors as discussed in Ballé, J., et al., End-to-end Optimized Image Compression, INTERN'L CONF. ON LEARNING REPRESENTATIONS (2017) (“Ballé 2017”) and Ballé, J., et al., Variational Image Compression with a Scale Hyperprior, INTERN'L CONF. ON LEARNING REPRESENTATIONS (2018) (“Ballé 2018”) have shown promise for many types of sources, including for point cloud data considering both for geometry and attribute coding parts per Pang, Jiahao, et al., GRASP-Net: Geometric Residual Analysis and Synthesis for Point Cloud Compression, PROCEEDINGS OF 1ST INTERN'L WORKSHOP ON ADV. IN POINT CLOUD COMPRESSION, PROCESSING, AND ANALYSIS (APCCPA '22) (2022) (“Pang”).

However, the recent analyses of Bhadane, S., et al., Do Neural Networks Compress Manifolds Optimally?, 2022 IEEE INFO. THEORY WORKSHOP (ITW) (2022) (“Bhadane”) and Ozyilkan, E., et al., Neural Distributed Compressor Discovers Binning, 5 IEEE J. SELECTED AREAS IN INFO. THEORY 246-260 (2024) (“Ozyilkan 2024”) highlight a significant limitation emerging in this class of end-to-end learned compressors by empirically showing that these widely used neural compressors struggle to effectively learn non-contiguous quantization bins in the latent space. As a result, these compressors are understood to be unable to optimally compress data with specific structures, such as those with sharp edges (according to Bhadane) or those with side/contextual information (according to Ozyilkan 2024).

Scalar Quantization (SQ) Vs. Vector Quantization (VQ)

Most popular work in end-to-end learned lossy compression falls under nonlinear transform coding (NTC), which incorporates an entropy bottleneck component to estimate the ‘rate’ of the induced bitstream obtained through arithmetic coding, according to Ballé 2017 and Ballé 2018. The entropy bottleneck component is a process block used for end-to-end training of learning-based compression system. The entropy bottleneck component takes a feature map as an input and outputs a distorted (quantized) version of the input feature map. The entropy bottleneck component also outputs the bitrate of the feature map for end-to-end rate-distortion optimization. Balle 2017 and Balle 2018 provide more details. NTC handles the joint optimization process for rate and distortion by mapping source data into a latent space using learnable nonlinear transforms, and then individually quantizing (via scalar quantization [SQ]) and coding each dimension in this space, according to Balle, J., et al., Nonlinear Transform Coding, 15:2 IEEE J. SELECTED TOPICS IN SIGNAL PROC. 339-353 (2021) (“Ballé 2021”). NTC-based quantization schemes are indirectly defined through the nonlinear transforms at the encoder and the decoder, where the former one dictates the quantization boundaries, and the latter determines the effective codebook vectors according to Ballé 2021. This significantly differs from traditional vector quantization (VQ), such as Lloyd-Max algorithm described in Lloyd, S., Least Squares Quantization in PCM, 28:2 IEEE TRANS. INFO. THEORY 129-137 (1982) (“Lloyd”), where the codebook vectors are constructed explicitly.

One alternative to overcome the learning biases (according to Bhadane and Ozyilkan 2024) emerging in NTC-based compressors is to replace this popular class of neural methods with a more unconstrained compression approach such as an entropy-constrained vector quantization described in Chou, P. A., et al., Entropy-Constrained Vector Quantization, 37:1 IEEE TRANS. ACOUSTICS, SPEECH, AND SIGNAL PROC. 31-42 (1989) (“Chou”). Such an approach has more degrees of freedom and has the potential to better compress complex sources including point cloud data.

Entropy-constrained vector quantization (ECVQ) and entropy-constrained scalar quantization (ECSQ) are both well-known techniques used in data compression, but they differ primarily in how they handle data. The ECSQ approach quantizes each of the latent dimensions (e.g., transform coefficients in the NTC case) independently, in which each individual scalar value is mapped to a discrete value from a set of quantization levels (e.g., integer values in the NTC case).

The ECVQ method instead quantizes altogether a vector of input samples simultaneously. The input vector is mapped to a representative codeword from a codebook, which may capture correlations between the samples more efficiently due to jointly processing them.

In the NTC case, since the latent elements follow a continuous probability distribution throughout training, there is an additional step to evaluate an appropriate discrete distribution that should match the probability induced by the quantized latents during inference. This matching is done by integrating over quantization bins, which are around integer values for each of the latent dimensions. The obtained discrete probability distribution may then be used to create a “codebook table,” which may be used by an arithmetic coder to optimally code the quantized elements in a lossless fashion.

### SQ in PCC

In point cloud data compression (PCC), neural methods based on NTC optimize a rate-distortion (R-D) objective, where a distortion metric is a suitable distortion metric, such as the Chamfer distance or the Earth Mover's distance. As such, the learned encoder (analysis transform) and learned decoder (synthesis transform) map data to and from a latent space by using quantization (rounding to integers) and running a learned probability distribution model over the quantized latents. Since the latents are rounded during quantization to the nearest integer in the latent space, the NTC approach effectively employs entropy-constrained “scalar” quantization for compression.

For some embodiments, the encoding and decoding processes of a scalar quantization process include the following four steps.

Step 1 is the analysis transform at the encoder. The encoder transforms the point cloud data into a latent representation using an analysis transform. This latent representation captures the essential features of the point cloud but in a more compact form.

Step 2 converts latent representation into discrete values through quantization (by rounding to the nearest integer in each of the dimensions). These discrete values may be arithmetic encoded (AE) using the “codebook table” induced by the estimated probability distribution over quantized values, which yield a bitstream to be transmitted to the decoder.

Step 3 decodes this bitstream into quantized/discrete latent representation. Since the encoder and decoder share an estimate of the probabilities, the decoder may perform arithmetic decoding (AD) to obtain quantized latent representations from the received bitstream.

Step 4 is the final synthesis transform at the decoder. The decoder takes the quantized latent representation and reconstructs an approximation of the input point cloud data using a synthesis transform.

In this application, as an alternative to the popular class of NTC-based neural compressors, an entropy-constrained vector quantization-based entropy bottleneck may be used for point cloud-related feature compression. An entropy-constrained vector quantization-based entropy bottleneck is a process block for end-to-end training of learning-based compression system based on vector quantization. An entropy-constrained vector quantization-based entropy bottleneck takes a feature map (which includes one-hot vectors) as input and outputs the estimated bitrate to encode the input feature map. Different from the traditional entropy bottleneck component, an entropy-constrained vector quantization-based entropy bottleneck is based on vector quantization rather than scalar quantization.

To accommodate such an entropy bottleneck in an end-to-end learned compression framework, the neural encoder may be specifically modified to function more like a classification network, directly outputting the quantization index as a one-hot vector. A one-hot vector is a vector in which a single value is “1” and every other value is zero. This learned encoder, paired with a corresponding learned decoder, is combined with a neural parametrized entropy bottleneck that learns the marginal distribution over the one-hot codewords/indexes produced by the encoder. This methodology is understood, in the following 4 aspects, to differ from other approaches that compress point cloud data.

Firstly, in nonlinear transform coding (NTC), the encoder outputs need to be evaluated in an appropriately discrete fashion before they may be used for arithmetic coding, requiring an additional processing step to create a suitable “codebook table.” The codebook table is fixed before performing inference encoding and decoding. In contrast, for some embodiments, the VQ method used herein outputs one-hot indexes directly, allowing them, along with the associated discrete probabilities, to be immediately inputted into an arithmetic coder without additional processing. By processing point cloud features, the encoder directly outputs one-hot codewords instead of latent vectors operating in the (ordered) real-line, which is the case for NTC-based models. Note that “codewords” and “latent vectors” are inter-changeable; both terms may be used to point to the neural network output features that are to be (en)coded or have been decoded. One-hot codewords are codewords or latent vectors that include one-hot vectors obtained with vector quantization. The concept of latent vectors operating in the (ordered) real-line means that the codewords/latent vectors are obtained with scalar quantization.

Secondly, the neural compressor operates in an unordered categorical space, where the encoder resembles a classification network that outputs the category (in the form of a one-hot vector) of the quantization index. Compared to NTC, the encoding instead leverages entropy-constrained vector quantization, which may better compress point cloud data by learning high-frequency functions and non-contiguous quantization bins according to Ozyilkan 2024 and Özyilkan, E., et al., Learned Wyner-Ziv Compressors Recover Binning, 2023 IEEE INTERN'L SYMPOSIUM INFO. THEORY (ISIT), Taipei, Taiwan (2023) (“Özyilkan 2023”.

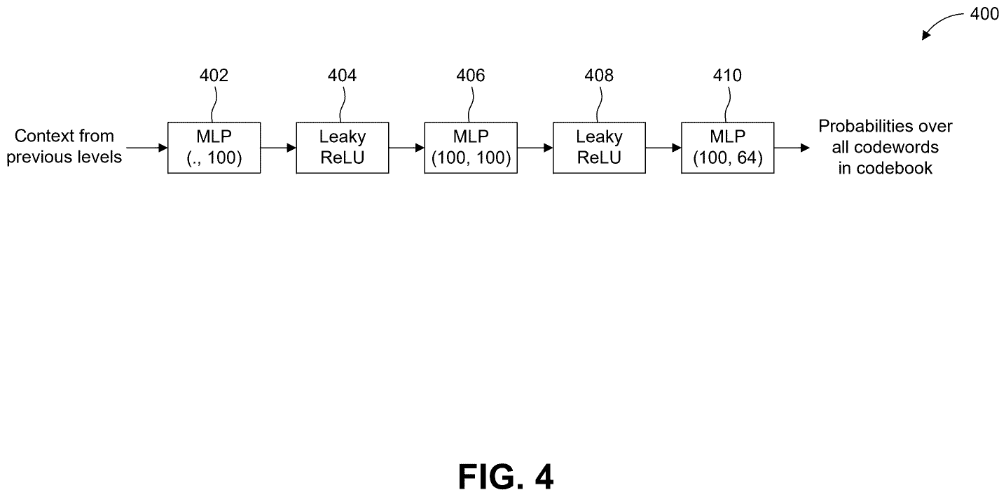

Thirdly, a probability estimator is a neural parametrized entropy bottleneck operating on the fixed-size codebook, which includes one-hot codewords. See the discussion below regarding FIG. 4 for the probability estimator, where the codebook size is set to be 64.

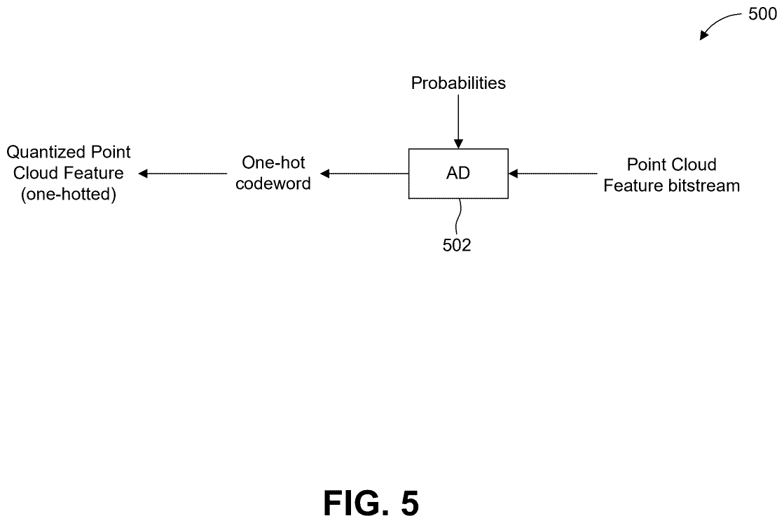

Fourthly, the decoder reconstructs an approximate point cloud data by processing the one-hot codeword sent via a bitstream. See the discussion below regarding FIG. 5 for the decoding method.

### Feature Encoder Outputting One-Hot Indexes

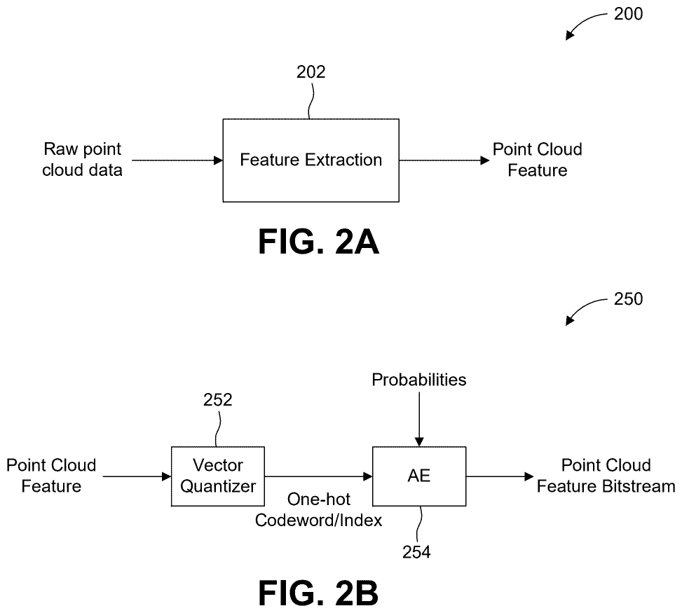

FIG. 2A is a process diagram illustrating an example feature extraction from point cloud data according to some embodiments. FIG. 2B is a process diagram illustrating an example feature encoding using vector quantization according to some embodiments.

An example point cloud feature encoder may be composed of the two steps 200, 250 shown in FIGS. 2A and 2B. The raw point cloud data undergoes feature extraction 202 as seen in FIG. 2A. The extracted point cloud feature is passed through a vector quantizer 252 to generate a one-hot codeword as the encoder's output. The one-hot codeword is arithmetically coded into one or more point cloud feature bitstreams by an arithmetic encoder (AE) 254.

FIG. 3 is a process diagram illustrating example pre-arithmetic encoder processing according to some embodiments. A breakdown of an example vector quantizer 300 is further shown in FIG. 3. The feature encoder is in the form of a vector quantizer, as shown in FIG. 3. The point cloud feature encoder outputs one-hot indexes, similar in spirit to a classification network for some embodiments, which may be implemented in various ways.

The point cloud feature is passed through concatenated layers of a multilayer perceptrons (MLP) 302, 306, 310 and interspersed with leaky rectifier linear units (ReLU) 304, 308 for some embodiments. In FIG. 3, the numbers “(100, 64)” indicate an input dimension of 100 and an output dimension of 64, which corresponds to a pre-determined number of available codewords in the codebook. The output dimension of 64 of the last MLP 310 may be thought of as the feature encoder's “confidence” over all 64 corresponding codewords. In box 302, the period (“.”) is a wildcard character, meaning that the input point cloud can have any dimension or channel size. For example, the period could be replaced with the number 64. The choice of codebook size depends on the desired rate region. For higher rates, a larger codebook, containing more one-hot indexed codewords, may be needed for some embodiments while a smaller codebook with fewer codewords may be sufficient for low rates.

By computing the argmax value (via an argmax process 312) over the “confidence” values learned by the feature encoder, the vector quantizer may output one-hot indexes corresponding to the selected quantization category/index (or indexes) associated with the input features.

### Probability Estimator (Available at Encoder and Decoder) for Codewords in Vector Quantizer

After obtaining one-hot indexes/codewords at the encoder output, a probability model for the marginal (discrete) distribution over all the codewords available in the codebook may be used to entropy code the quantized representation. Such a probability model may be used by an arithmetic coder to compress discrete-valued data to bit rates closely approaching the ultimate limit of compression, which is the “entropy” of the representation, according to Rissanen, J. and G. Langdon, Universal Modeling and Coding, 27:1 IEEE TRANS. INFO. THEORY 12-23 (1981) (“Rissanen”). As such, entropy coding relies on a probability model of the quantized representation, which is assumed to be available to both the encoder and the decoder, to carry out arithmetic encoding (AE) and arithmetic decoding (AD), respectively.

FIG. 4 is a process diagram illustrating an example probability estimator for codewords in a vector quantizer according to some embodiments. For some embodiments, an example probability estimator, which is available both at the encoder and the decoder, is tailored for the feature encoder using vector quantization, which is depicted in FIG. 3.

For some embodiments, data in context from previous levels is passed through concatenated layers of a multilayer perceptrons (MLP) 402, 406, 410 and interspersed with leaky rectifier linear units (ReLU) 404, 408. The context data may be any information about the previous-level point cloud data. In some embodiments, the context data is the feature extracted from the previous-level point cloud. In FIG. 4, the numbers “(100, 64)” in the last MLP block 410 indicate an input dimension of 100 and an output dimension of 64. In box 402, the period (“.”) is a wildcard character, meaning that the input point cloud can have any dimension or channel size. For example, the period could be replaced with the number 64. For some embodiments, the probability estimator outputs unnormalized log-probabilities (logits) over all 64 possible codewords available in the codebook. An entropy model operating on discrete one-hot indexed codewords may be parameterized by using the relationship shown in Eq. 1:

$${P}_{k} = \frac{( exp {α}_{k} )}{{\sum }_{i = 1}^{K} exp {α}_{i}} , k ∈ \{ 1 , … , K \} \qquad ( 1 )$$

where αₖ is the logit value associated with each codeword. For the examples shown in FIGS. 3 and 4, K=64.

### Feature Decoder Taking One-Hot Indexes as Input

FIG. 5 is a process diagram illustrating an example feature decoder using vector quantization according to some embodiments. An example feature decoder 500, which further processes the output of vector quantization, is shown in FIG. 5. This feature decoder 500 receives the point cloud feature bitstream from the encoder. The feature decoder is assumed to have access to the (discrete) probability model which is used by encoder to carry out arithmetic coding for the lossless compression of the quantized representation. Using the available probability estimator, the decoder may then perform arithmetic decoding (AD) 502 to retrieve the exact same one-hot codeword/index (or indices) that were encoded at the encoder side. These indices are used to obtain a quantized point cloud feature (one-hotted).

Comparing FIG. 5 with FIG. 2B, there is no vector de-quantizer in FIG. 5 because the outputs of the arithmetic decoder AD are one-hot codewords. The one-hot codeword outputs are already “dequantized” features in the sense of vector quantization.

Lossy Point Cloud Compression with Vector Quantization

In lossy point cloud compression, 3D convolutions may be leveraged to efficiently exploit voxel correlations within a 3D space. Inspired by the success of 2D convolutions in capturing redundancies in 2D images, the popular class of end-to-end lossy compression methods (such as the ones discussed in Ballé 2017 and Ballé 2018) used in images may be extended to three dimensions, in which 3D convolutions are used to extract features that compactly represent the point cloud data.

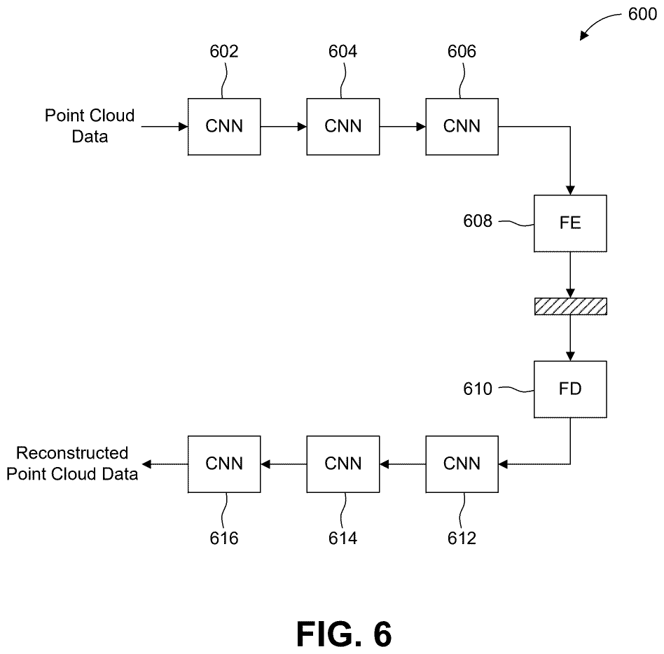

FIG. 6 is a process diagram illustrating example vector quantization for lossy point cloud compression according to some embodiments. For some embodiments, an exemplary placement of the vector quantization for a lossy point cloud compression process 600 is shown in FIG. 6.

In a similar spirit to the feature extraction shown in FIG. 2, the goal of the concatenated layer of 3D convolutional neural network (CNN) blocks 602, 604, 606 depicted in FIG. 6 is to perform feature extraction from point cloud data. By stacking these 3D convolutions with nonlinear activations, the method may effectively capture the spatial relationships between voxels, similar to how 2D image blocks are synthesized through 2D convolutions. In FIG. 6, the FE block 608 corresponds to the vector quantizer 252 coupled with the arithmetic coder 254 as shown in FIG. 2B (which includes the vector quantization shown more detailed in FIG. 3). The FD block 610 corresponds to the arithmetic decoder 502 shown in FIG. 5. For some embodiments, the decoder may include a series of CNN blocks 612, 614, 616, as shown in FIG. 6, that correspond to the series of CNN blocks 602, 604, 606 in the encoder.

Octree-Based Point Cloud Compression with Vector Quantization

Octree-based lossless point cloud compression is a widely used method that efficiently organizes and compresses 3D data by recursively partitioning the space into smaller cubes, or octants. This technique uses the spatial structure of point clouds by creating a hierarchical tree, known as an octree, in which each node represents a cubic region of space. As the tree is built, the space is subdivided, and points are grouped into these octants, with further subdivision continuing until each leaf node contains a small number of points or a single point. This hierarchical structure allows for a compact representation of the point cloud, in which empty or sparsely populated regions may be effectively compressed by not storing unnecessary data. The octree-based approach is particularly suitable for lossless compression because the approach preserves the exact original data without any loss of detail.

As the octree is constructed, each node's occupancy (which is a status indicating whether the node contains points or the node is empty) may be predicted using statistical or learning-based models, which leverage the distribution of points in the parent nodes. By estimating these occupancy probabilities, a lossless compression algorithm may effectively encode the presence or absence of points (which may be represented as binary information) within each subdivided region.

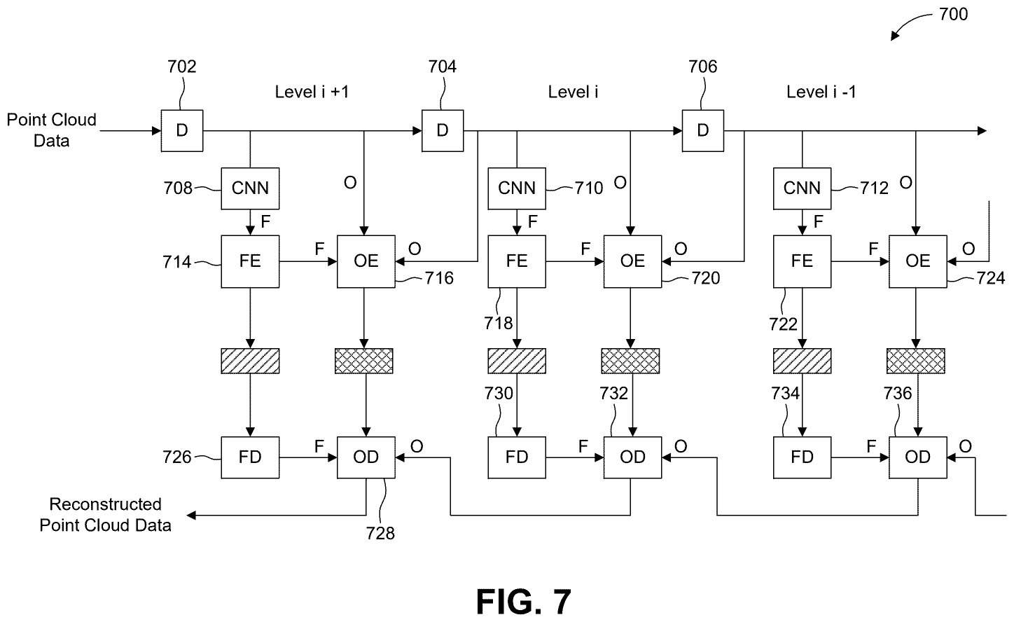

FIG. 7 is a process diagram illustrating an example vector quantization for lossless point cloud compression according to some embodiments. For some embodiments, an exemplary placement of the vector quantization for an octree-based lossless point cloud compression process 700 is shown in FIG. 7. This example process 700 is built on top of an example design shown in the '144 application.

The input point cloud data is sampled by the “D” blocks 702, 704, 706. For some embodiments, the sampled data may be passed through CNN blocks 708, 710, 712 prior to going through feature encoder blocks 714, 718, 722. The OE blocks 716, 720, 724 and the OD blocks 728, 732, 736 denote the occupancy encoder and occupancy decoder, respectively, corresponding to the extraction of occupancy information. The features reconstructed from the feature encoding blocks 714, 718, 722 and feature decoding 726, 730, 734 blocks are used to assist the OE and OD blocks, which carry out lossless compression. For feature encoding, see the examples in FIGS. 2 and 3. For feature decoding, see the example in FIG. 5. In the exemplary scheme for lossless compression, the OE blocks 716, 720, 724 take as inputs the occupancy information (“O” lines in FIG. 7) based on the parent level (already encoded) and the current level (to be encoded). Additionally, the features extracted from the current level are provided to assist the encoding “OE” blocks 716, 720, 724 with a high-level description of local geometry information. On the decoder side, the features (“F” lines in FIG. 7) to assist the decoding “OD” blocks 728, 732, 736 are extracted from a feature bitstream by feature decoders 726, 730, 734. More details of the procedure may be found in in the '144 application.

A vector quantizer (VQ) process is applied to enhance the coding of features. In particular, the “FE” block 714, 718, 722 is a vector quantizer (VQ) coupled with an arithmetic encoder. The “FD” block 726, 730, 734 is a vector dequantizer coupled with an arithmetic decoder.

### Vector Quantization in Learning-Based Image/Video Compression

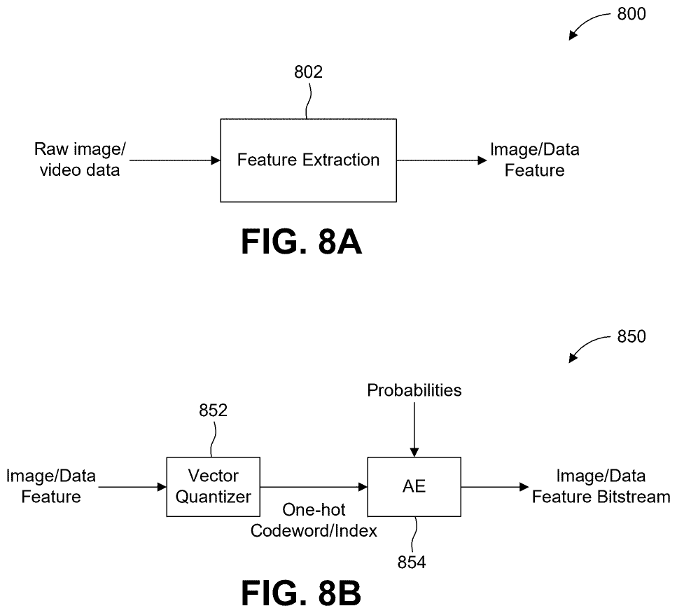

FIG. 8A is a process diagram illustrating an example feature extraction from image/video data according to some embodiments. FIG. 8B is a process diagram illustrating an example feature encoding for image/video data using vector quantization according to some embodiments.

Although use cases for entropy-constrained vector quantization have been discussed only in the context of point-cloud compression, the method is a “plug-and-play” component that may be tailored to many other end-to-end compression schemes. For example, in the context of having image and/or video data as the input source, the feature encoding scheme and accompanying entropy bottleneck discussed above may be used to entropy code the quantized representation of the extracted features coming from the image and/or video data.

See FIGS. 8A and 8B for an exemplary image/video feature encoding process 800, 850 that uses the vector quantization scheme explained above regarding FIGS. 2A and 2B. The raw point cloud data undergoes feature extraction 802 as seen in FIG. 8A. The extracted point cloud feature is passed through a vector quantizer 852 to generate a one-hot codeword as the encoder's output. The one-hot codeword is arithmetically coded into one or more point cloud feature bitstreams by an arithmetic encoder (AE) 854. More details on possible placements of the vector quantization for a lossy end-to-end image/video compression pipeline are provided below.

Lossy Image/Video Compression with Vector Quantization

In the context of image compression, 2D CNNs play a crucial role in feature extraction from input image or video data. These networks apply convolutional filters across the spatial dimensions of the input data, through which they effectively capture the local patterns and structures e.g., edges, textures and shapes. By stacking multiple layers of convolutions with nonlinear activations, CNNs progressively capture these features, creating a hierarchical representation that distills the essential information from the input image/video. The goal of concatenated layers of CNNs in image/video compression is operationally similar to the feature extraction depicted in FIG. 8A.

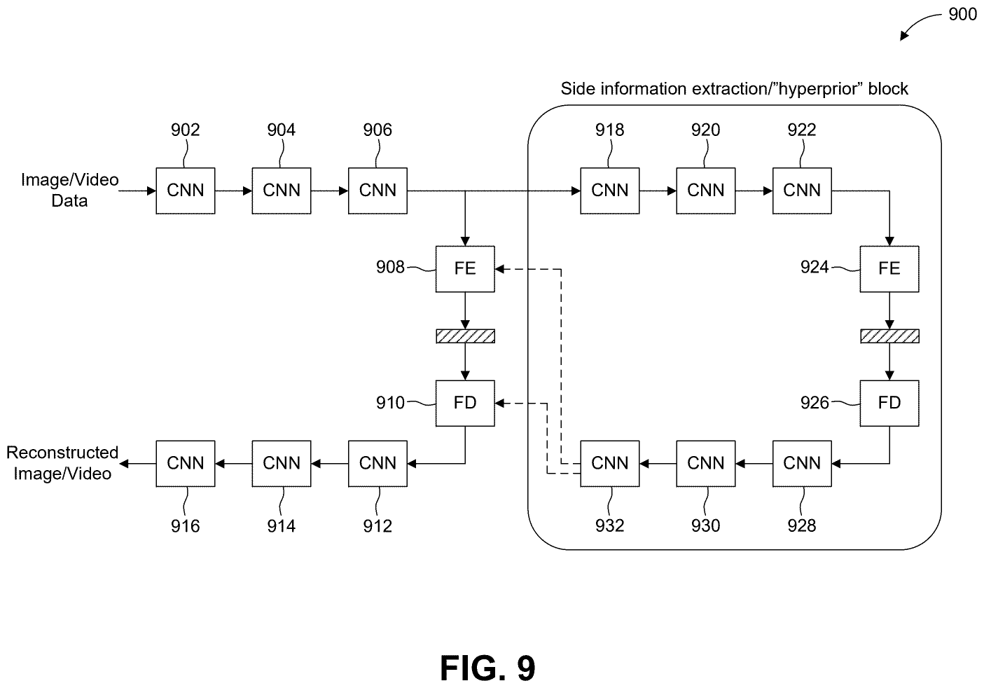

FIG. 9 is a process diagram illustrating an example vector quantization for lossy image/video compression according to some embodiments. For some embodiments, an exemplary placement of the vector quantization for a lossy image/video compression process 900 is shown in FIG. 9, which builds onto the end-to-end “hyperprior” model introduced in the Ballé 2018 article.

By leveraging the “side information” (also known as “hyperprior”) model, originally proposed in Ballé 2018, the vector quantization component may be integrated into a lossy end-to-end image and video compression framework. As explained in Ballé2018, the hyperprior model introduces a “side information” mechanism that further captures the dependencies within the latent representations. This side information is encoded into a separate bitstream, as seen on the right-hand side of FIG. 9. This side information carries additional bits of information sent from the encoder and to the decoder. Although an additional bitstream is sent to the decoder in this case, enabling a more flexible probability model on the quantized latent representations offers a superior method for modeling dependencies between them according to Bishop, C. M., Latent Variable Models, LEARNING IN GRAPHICAL MODELS, 371-403, MIT Press (1999) (“Bishop”). Therefore, this additional bitstream yields an overall reduction in the coding cost. This overall reduction occurs because the introduction of these “side information” variables allows the latent representations to be considered independent when conditioned on them, which offers a more flexible probability model for the quantized latents compared to the entropy modelling previously proposed in Ballé2017.

A VQ process may be utilized to improve the coding of both the quantized latent representations and the accompanying “side information”/“hyperprior” representations. For some embodiments, as shown in FIG. 9, both “FE” blocks 908, 924 refer to a vector quantizer combined with an arithmetic encoder (shown in FIG. 8B) while both “FD” blocks 910, 926 represent a vector dequantizer with an arithmetic decoder (shown in FIG. 4).

This application provides an alternative way to compress point-cloud data end-to-end by leveraging an entropy-constrained vector quantization (VQ) process. An encoder, acting similar to a classification network, directly outputs the category of the quantization index in the form of a one-hot vector. These one-hot indexes are encoded into a bitstream, and the bitstream is sent to the decoder. The decoder outputs a reconstructed point cloud, image, or video data by processing the recovered one-hot indexes from the bitstream.

For some embodiments, a concatenated layer of 3D convolutional neural network (CNN) blocks 902, 904, 906 perform feature extraction from image/video data. These features are encoded with a feature encoder (FE) 908. On the decoder side, the received bitstream is decoded with a feature decoder (FD) 910. The output of the feature decoder 910 goes through a concatenated layer of 3D convolutional neural network (CNN) blocks 912, 914, 916 to reconstruct the image/video data. As discussed above, a side information extraction/“hyperprior” process block may be used to generate additional information for the feature encoder 908 and the feature decoder 910. For some embodiments, a side information extraction/“hyperprior” block may include a concatenated layer of 3D convolutional neural network (CNN) blocks 918, 920, 922 perform additional feature extraction to further capture dependencies within the latent representations. This additional information is sent to a feature encoder 924 to generate a “side information” bitstream. On the decoder side, the “side information” bitstream goes through a feature decoder 926 to decode the bitstream. The decoded “side information” bitstream is passed through a series of CNN blocks 928, 930, 932 to generate side information for the feature encoder block 908 and the feature decoder block 910. The feature decoder 926 and the CNN blocks 928, 930, 932 also exist on the encoder side so that the side information outputted by the CNN block 932 may be provided to the feature encoder (FE) 908 to generate the bitstream for some embodiments.

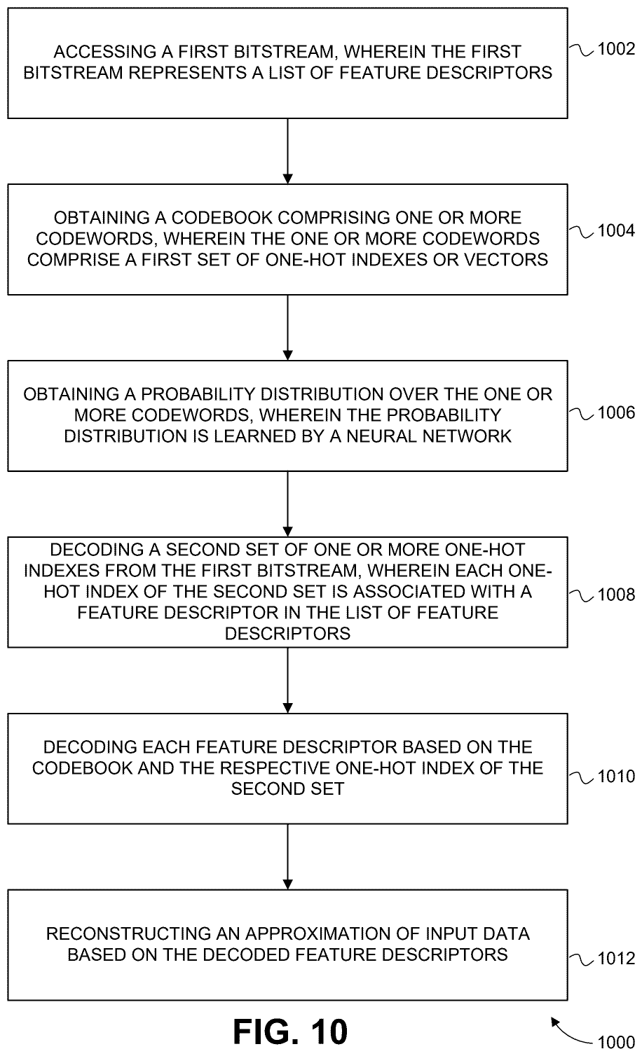

FIG. 10 is a flowchart illustrating an example decoding process according to some embodiments. For some embodiments, an example process 1000 may include accessing 1002 a first bitstream, wherein the first bitstream represents a list of feature descriptors. For some embodiments, the example process 1000 may further include obtaining 1004 a codebook comprising one or more codewords, wherein the one or more codewords comprise a first set of one-hot indexes or vectors. For some embodiments, the example process 1000 may further include obtaining 1006 a probability distribution over the one or more codewords, wherein the probability distribution is learned by a neural network. For some embodiments, the example process 1000 may further include decoding 1008 a second set of one or more one-hot indexes from the first bitstream, wherein each one-hot index of the second set is associated with a feature descriptor in the list of feature descriptors. For some embodiments, the example process 1000 may further include decoding 1010 each feature descriptor based on the codebook and the respective one-hot index of the second set. For some embodiments, the example process 1000 may further include reconstructing 1012 an approximation of input data based on the decoded feature descriptors.

For some embodiments, the first set of one-hot indexes are the entire codebook and contain all possible one-hot indexes that may be used in the codec, while the second set of one-hot indexes are decoded from the first bitstream representing the list of feature descriptors.

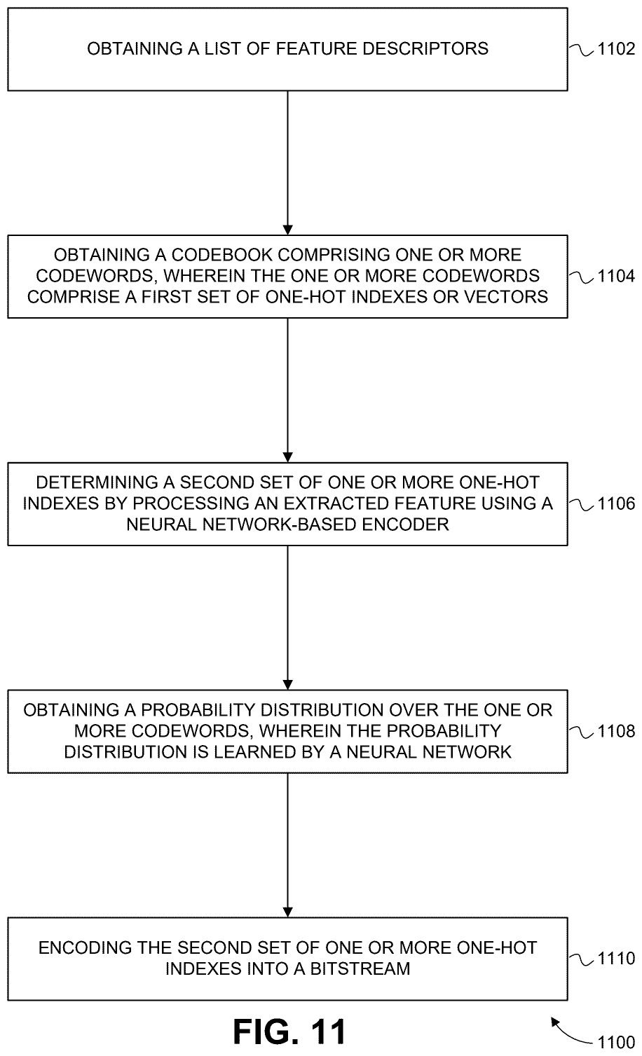

FIG. 11 is a flowchart illustrating an example encoding process according to some embodiments. For some embodiments, an example process 1100 may include obtaining 1102 a list of feature descriptors. For some embodiments, the example process 1100 may further include obtaining 1104 a codebook comprising one or more codewords, wherein the one or more codewords comprise a first set of one-hot indexes or vectors. For some embodiments, the example process 1100 may further include determining 1106 a second set of one or more one-hot indexes by processing an extracted feature using a neural network-based encoder. For some embodiments, the example process 1100 may further include obtaining 1108 a probability distribution over the one or more codewords, wherein the probability distribution is learned by a neural network. For some embodiments, the example process 1100 may further include encoding 1110 the second set of one or more one-hot indexes into a bitstream.

An example apparatus in accordance with some embodiments may include at least one processor configured to perform any one of the methods described within this application. An example apparatus in accordance with some embodiments may include a computer-readable medium storing instructions for causing one or more processors to perform any one of the methods described within this application. An example apparatus in accordance with some embodiments may include at least one processor and at least one non-transitory computer-readable medium storing instructions for causing the at least one processor to perform any one of the methods described within this application. An example signal in accordance with some embodiments may include a bitstream generated according to any one of the methods described within this application.

While the methods and systems in accordance with some embodiments are generally discussed in context of extended reality (XR), some embodiments may be applied to any XR contexts such as, e.g., virtual reality (VR)/mixed reality (MR)/augmented reality (AR) contexts. Also, although the term “head mounted display (HMD)” is used herein in accordance with some embodiments, some embodiments may be applied to a wearable device (which may or may not be attached to the head) capable of, e.g., XR, VR, AR, and/or MR for some embodiments.

A first example method in accordance with some embodiments may include: accessing a first bitstream, wherein the first bitstream represents a list of feature descriptors; obtaining a codebook comprising one or more codewords, wherein the one or more codewords comprise a first set of one-hot indexes or vectors; obtaining a probability distribution over the one or more codewords, wherein the probability distribution is learned by a neural network; decoding a second set of one or more one-hot indexes from the first bitstream, wherein each one-hot index of the second set is associated with a feature descriptor in the list of feature descriptors; decoding each feature descriptor based on the codebook and the respective one-hot index of the second set; and reconstructing an approximation of input data based on the decoded feature descriptors.

For some embodiments of the first example method, the list of feature descriptors corresponds to a point cloud.

For some embodiments of the first example method, the list of feature descriptors corresponds to an image.

For some embodiments of the first example method, the list of feature descriptors corresponds to video data.

For some embodiments of the first example method, obtaining the probability distribution over the one or more codewords comprises passing context data through one or more multi-layer perceptron (MLP) blocks and one or more rectifier linear unit (ReLU) blocks.

For some embodiments of the first example method, decoding the one or more one-hot indexes comprises: obtaining one or more features from the first bitstream; and passing the one or more features through an arithmetic decode process to generate the one or more one-hot indexes, wherein the arithmetic decode process uses the probability distribution as an input parameter.

Some embodiments of the first example method may further include extracting side information from a second bitstream, wherein the second bitstream comprises feature encoded information corresponding to the input data, and wherein decoding each feature descriptor further uses the extracted side information.

For some embodiments of the first example method, obtaining the probability distribution comprises using a neural parameterized entropy bottleneck process operating on the codebook.

For some embodiments of the first example method, the approximation of the input data comprises a quantized version of an image or data feature.

For some embodiments of the first example method, the approximation of the input data comprises a quantized version of a point cloud feature.

A first example apparatus in accordance with some embodiments may include: a processor; and a memory storing instructions operative, when executed by the processor, to cause the apparatus to: access a first bitstream, wherein the first bitstream represents a list of feature descriptors; obtain a codebook comprising one or more codewords, wherein the one or more codewords comprise a first set of one-hot indexes or vectors; obtain a probability distribution over the one or more codewords, wherein the probability distribution is learned by a neural network; decode a second set of one or more one-hot indexes from the first bitstream, wherein each one-hot index of the second set is associated with a feature descriptor in the list of feature descriptors; decode each feature descriptor based on the codebook and the respective one-hot index of the second set; and reconstruct an approximation of input data based on the decoded feature descriptors.

A second example method in accordance with some embodiments may include: obtaining a list of feature descriptors; obtaining a codebook comprising one or more codewords, wherein the one or more codewords comprise a first set of one-hot indexes or vectors; determining a second set of one or more one-hot indexes by processing an extracted feature using a neural network-based encoder; obtaining a probability distribution over the one or more codewords, wherein the probability distribution is learned by a neural network; and encoding the second set of one or more one-hot indexes into a bitstream.

For some embodiments of the second example method, obtaining the list of feature descriptors comprises extracting the list of feature descriptors using a neural network.

For some embodiments of the second example method, obtaining the list of feature descriptors comprises extracting the list of feature descriptors from a point cloud, an image, or video data.

For some embodiments of the second example method, obtaining the list of feature descriptors comprises generating the list of feature descriptors from scratch.

For some embodiments of the second example method, obtaining the probability distribution over the one or more codewords comprises passing context data through one or more multi-layer perceptron (MLP) blocks and one or more rectifier linear unit (ReLU) blocks.

For some embodiments of the second example method, determining the second set of one or more one-hot indexes comprises: obtaining one or more features; and passing the one or more features through an arithmetic decode process to generate the second set of one or more one-hot indexes, wherein the arithmetic decode process uses the probability distribution as an input parameter.

Some embodiments of the second example method may further include: extracting side information from the extracted feature; and encoding the extracted feature into a second bitstream, wherein encoding the extracted feature uses the extracted side information as a parameter.

For some embodiments of the second example method, at least one of the feature descriptors of the list of feature descriptors corresponds to an image or data feature.

For some embodiments of the second example method, at least one of the feature descriptors of the list of feature descriptors corresponds to a point cloud feature.

One or more embodiments provide a computer program comprising instructions which when executed by one or more processors cause such processors to perform the encoding and/or decoding methods according to any of the embodiments described above. One or more embodiments also provide a computer readable storage medium having stored thereon instructions for encoding or decoding video data according to the methods described above.

One or more embodiments provide a computer readable storage medium having stored thereon video data generated according to the methods described above. One or more embodiments also provide a method and apparatus for transmitting or receiving video data generated according to the methods described above.

The embodiments described herein may be implemented in, for example, a method or a process, an apparatus, a software program, a data stream, or a signal. Even if only discussed in the context of a single form of implementation (e.g., as a method), the implementation of such features may also be implemented in other forms. An apparatus may be implemented in, for example, appropriate hardware, software, and firmware. Corresponding methods may be implemented in, for example, a processor.

Various numeric values are used in the present application. Such specific values are for example purposes and the embodiments described are not limited to these specific values.

Various methods are described herein, and such methods comprise one or more steps or actions for achieving the described method. Unless a specific order of steps or actions is required for the proper operation of the method, the order and/or use of specific steps and/or actions may be modified or combined. Additionally, terms such as “first”, “second”, etc. may be used in various embodiments to modify an element, component, step, operation, etc., for example, a “first decoding” and a “second decoding”. Use of such terms does not imply an order to the operations unless specifically required.

The present application may refer to “determining” various pieces of information. Determining information may include one or more of, for example, estimating, calculating, predicting, or retrieving (e.g., from memory) the information.

The present application may refer to “accessing” various pieces of information. Accessing information may include one or more of, for example, receiving, retrieving (e.g., from memory), storing, moving, copying, calculating, determining, predicting, or estimating the information. Similarly, the present application may refer to “receiving” various pieces of information. Receiving information may include one or more of, for example, accessing or retrieving (e.g., from memory) the information.

It is to be understood that use of any of the following “/”, “and/or”, and “at least one of” is intended to encompass all possible selections of listed items, taken either individually or in any combination thereof.

While specific embodiments have been described in the foregoing description in connection with the accompanying drawings, it should be understood that embodiments described herein are examples only and should not be taken as limiting the scope of the present application or the following claims. Although features and elements are described herein in particular combinations, those of ordinary skill in the art will appreciate that such features or elements may be used alone or in any combination with the other features and elements. It is understood, therefore, that the overall teachings of the present application are not limited to the particular embodiments, implementations, and examples disclosed herein, but are intended to cover variations, modifications, and alternatives as defined by the appended claims and any and all equivalents thereof.

This application describes a variety of aspects, including tools, features, embodiments, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects can be combined and interchanged to provide further aspects. Moreover, the aspects can be combined and interchanged with aspects described in earlier filings as well.

Various numeric values may be used in the present application, for example. The specific values are for example purposes and the aspects described are not limited to these specific values.

Embodiments described herein may be carried out by computer software implemented by a processor or other hardware, or by a combination of hardware and software. As a non-limiting example, the embodiments can be implemented by one or more integrated circuits. The processor can be of any type appropriate to the technical environment and can encompass one or more of microprocessors, general purpose computers, special purpose computers, and processors based on a multi-core architecture, as non-limiting examples.

When a figure is presented as a flow diagram, it should be understood that it also provides a block diagram of a corresponding apparatus. Similarly, when a figure is presented as a block diagram, it should be understood that it also provides a flow diagram of a corresponding method/process.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information can include one or more of, for example, estimating the information, calculating the information, predicting the information, or retrieving the information from memory.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items as are listed.

Implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

Note that various hardware elements of one or more of the described embodiments are referred to as “modules” that carry out (i.e., perform, execute, and the like) various functions that are described herein in connection with the respective modules. As used herein, a module includes hardware (e.g., one or more processors, one or more microprocessors, one or more microcontrollers, one or more microchips, one or more application-specific integrated circuits (ASICs), one or more field programmable gate arrays (FPGAs), one or more memory devices) deemed suitable by those of skill in the relevant art for a given implementation. Each described module may also include instructions executable for carrying out the one or more functions described as being carried out by the respective module, and it is noted that those instructions could take the form of or include hardware (i.e., hardwired) instructions, firmware instructions, software instructions, and/or the like, and may be stored in any suitable non-transitory computer-readable medium or media, such as commonly referred to as RAM, ROM, etc.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method comprising:
accessing a first bitstream,
wherein the first bitstream represents a list of feature descriptors;
obtaining a codebook comprising one or more codewords,
wherein the one or more codewords comprise a first set of one-hot indexes or vectors;
obtaining a probability distribution over the one or more codewords,
wherein the probability distribution is learned by a neural network;
decoding a second set of one or more one-hot indexes from the first bitstream,
wherein each one-hot index of the second set is associated with a feature descriptor in the list of feature descriptors;
decoding each feature descriptor based on the codebook and the respective one-hot index of the second set; and
reconstructing an approximation of input data based on the decoded feature descriptors.

2. The method of claim 1, wherein the list of feature descriptors corresponds to a point cloud.

3. The method of claim 1, wherein the list of feature descriptors corresponds to an image.

4. The method of claim 1, wherein the list of feature descriptors corresponds to video data.

5. The method of claim 1, wherein obtaining the probability distribution over the one or more codewords comprises passing context data through one or more multi-layer perceptron (MLP) blocks and one or more rectifier linear unit (ReLU) blocks.

6. The method of claim 1, wherein decoding the one or more one-hot indexes comprises:
obtaining one or more features from the first bitstream; and
passing the one or more features through an arithmetic decode process to generate the one or more one-hot indexes,
wherein the arithmetic decode process uses the probability distribution as an input parameter.

7. The method of claim 1, further comprising:
extracting side information from a second bitstream,
wherein the second bitstream comprises feature encoded information corresponding to the input data, and
wherein decoding each feature descriptor further uses the extracted side information.

8. The method of claim 1, wherein obtaining the probability distribution comprises using a neural parameterized entropy bottleneck process operating on the codebook.

9. The method of claim 1, wherein the approximation of the input data comprises a quantized version of an image or data feature.

10. The method of claim 1, wherein the approximation of the input data comprises a quantized version of a point cloud feature.

11. An apparatus comprising:
a processor; and
a memory storing instructions operative, when executed by the processor, to cause the apparatus to:
access a first bitstream,
wherein the first bitstream represents a list of feature descriptors;
obtain a codebook comprising one or more codewords,
wherein the one or more codewords comprise a first set of one-hot indexes or vectors;
obtain a probability distribution over the one or more codewords,
wherein the probability distribution is learned by a neural network;
decode a second set of one or more one-hot indexes from the first bitstream,
wherein each one-hot index of the second set is associated with a feature descriptor in the list of feature descriptors;
decode each feature descriptor based on the codebook and the respective one-hot index of the second set; and
reconstruct an approximation of input data based on the decoded feature descriptors.

12. A method comprising:
obtaining a list of feature descriptors;
obtaining a codebook comprising one or more codewords,
wherein the one or more codewords comprise a first set of one-hot indexes or vectors;
determining a second set of one or more one-hot indexes by processing an extracted feature using a neural network-based encoder;
obtaining a probability distribution over the one or more codewords,
wherein the probability distribution is learned by a neural network; and
encoding the second set of one or more one-hot indexes into a bitstream.

13. The method of claim 12, wherein obtaining the list of feature descriptors comprises extracting the list of feature descriptors using a neural network.

14. The method of claim 12, wherein obtaining the list of feature descriptors comprises extracting the list of feature descriptors from a point cloud, an image, or video data.

15. The method of claim 12, wherein obtaining the list of feature descriptors comprises generating the list of feature descriptors from scratch.

16. The method of claim 12, wherein obtaining the probability distribution over the one or more codewords comprises passing context data through one or more multi-layer perceptron (MLP) blocks and one or more rectifier linear unit (ReLU) blocks.

17. The method of claim 12, wherein determining the second set of one or more one-hot indexes comprises:
obtaining one or more features; and
passing the one or more features through an arithmetic decode process to generate the second set of one or more one-hot indexes,
wherein the arithmetic decode process uses the probability distribution as an input parameter.

18. The method of claim 12, further comprising:
extracting side information from the extracted feature; and
encoding the extracted feature into a second bitstream,
wherein encoding the extracted feature uses the extracted side information as a parameter.

19. The method of claim 12, wherein at least one of the feature descriptors of the list of feature descriptors corresponds to an image or data feature.

20. The method of claim 12, wherein at least one of the feature descriptors of the list of feature descriptors corresponds to a point cloud feature.
